(19) United States
(12) Patent Application Publication
(10) Pub. No.: US 2013/0124496 A1
(43) Pub. Date: May 16, 2013

(54) CONTEXTUAL PROMOTION OF ALTERNATIVE SEARCH RESULTS

(71) Applicants: TIMOTHY EDGAR, BELLEVUE, WA (US); AMBARISH CHITNIS, REDMOND, WA (US); RYEN WILLIAM WHITE, WOODINVILLE, WA (US); PAVEL DMITRIEV, BELLEVUE, WA (US); RAJANIKANTH AGEERU, BELLEVUE, WA (US); OVIDIU DAN, BETHLEHEM, PA (US); LIN TANG, BELLEVUE, WA (US)

(72) Inventors: TIMOTHY EDGAR, BELLEVUE, WA (US); AMBARISH CHITNIS, REDMOND, WA (US); RYEN WILLIAM WHITE, WOODINVILLE, WA (US); PAVEL DMITRIEV, BELLEVUE, WA (US); RAJANIKANTH AGEERU, BELLEVUE, WA (US); OVIDIU DAN, BETHLEHEM, PA (US); LIN TANG, BELLEVUE, WA (US)

(73) Assignee: MICROSOFT CORPORATION, REDMOND, WA (US)

(21) Appl. No.: 13/294,707

(22) Filed: Nov. 11, 2011

(51) Int. Cl. G06F 17/30

(52) U.S. Cl. 707/708; 707/E17.014; 707/E17.108; 707/E17.044

(57) ABSTRACT

A toolbar extension of a web browser suggests a user try searching a different search engine than the one on which the user has just conducted a search. The toolbar detects the user is frustrated with the search results returned by the search engine by monitoring a number of session heuristics. Analyzing historical user session, log, and click data of other users who have submitted the search query to different search engines, a different search engine is selected that has historically generated better search results. A suggestion is then presented to the user to run the search query in the more effective search engine. Such a suggestion may be presented in a number of ways, but one embodiment displays a window next to the text field of the toolbar and provides a link to conduct a search for the search query in the more effective search engine.

### BACKGROUND

Web searchers are often frustrated when they cannot find what they are looking for with a search engine. The ability of a user to navigate to useful information using a modern search engine still hinges not only on the accuracy of the user's search terms but also on the efficacy of the search engine used. People remain loyal to specific search engines and are generally less likely to explore other search engines that may produce better search results to their online queries.

### SUMMARY

This summary is provided to introduce a selection of concepts in a simplified form that are further described below in the Detailed Description. This summary is not intended to identify key features or essential features of the claimed subject matter. Nor is this summary intended to be used as an aid in determining the scope of the claimed subject matter.

One aspect is directed to a toolbar extension of a web browser that suggests a user try a different search engine when the toolbar detects the user is frustrated with search results. During a session, the toolbar determines a user submitted a search query to a search engine and the search engine returned and displayed results in a search results page. Analyzing historical user session data of other users who have submitted the search query to different search engines, a search engine is selected that has historically generated more effective search results. In addition to historical user session data of other users, some embodiments may query other search engines when a search query is submitted and compare search results returned by the other search engines to figure out the most, or at least more, effective search engine. A suggestion is then presented to the user to run the search query in the more effective search engine. Such a suggestion may be presented in a number of ways, but one embodiment displays a window next to the text field of the toolbar and provides a link to conduct a search for the search query in the more effective search engine. For example, a balloon may say something like, “Still Looking? Bing® has more results,” with any of the words being the link to run the search query in Bing®.

Another aspect is directed to displaying a suggestion to a user to search a try a different search engine when search for a search query. A toolbar on a web browser determines a user session has begun and detects that a search query was submitted to a search engine. The toolbar contacts a server that mines a data center storing historical session data for multiple users to determine whether a different search engine would yield a better search experience for the search query. If so, the different search engine is returned to the toolbar and suggested to the user. In one embodiment, the entity affiliated with the toolbar also owns a search engine that may be suggested to the user as the different search engine—thus driving traffic to the entity's search engine.

Another aspect is directed to a toolbar on a web browser that detects a user session has begun and a user has submitted a search query to a search engine. The toolbar interacts with a server that mines a data center storing historical session data for multiple users to determine whether a different search engine would yield a better search experience for the search query. To make such a determination, the server computes values based on different user session heuristics (e.g., abandonment rates, dwell times, clickthrough rates, quick backs, requerying, and pagination) to determine the most-effective search engine for the search query. Based on these computed values, a search engine is selected by the server and returned to the toolbar, which suggests that the user run the search query on the different search engine. A link to run the search query on the different search engine may also be included in the suggestion.

### BRIEF DESCRIPTION OF THE SEVERAL VIEWS OF THE DRAWINGS

Illustrative embodiments of the present invention are described in detail below with reference to the attached drawing figures, and wherein:

FIG. 1 is a block diagram of an exemplary computing environment suitable for implementing embodiments discussed herein.

FIG. 2 illustrates a screen shot of a web browser with a toolbar suggesting that a user try to a search query on a different search engine in accordance with one embodiment.

FIG. 3 illustrates a networked environment in accordance with one embodiment.

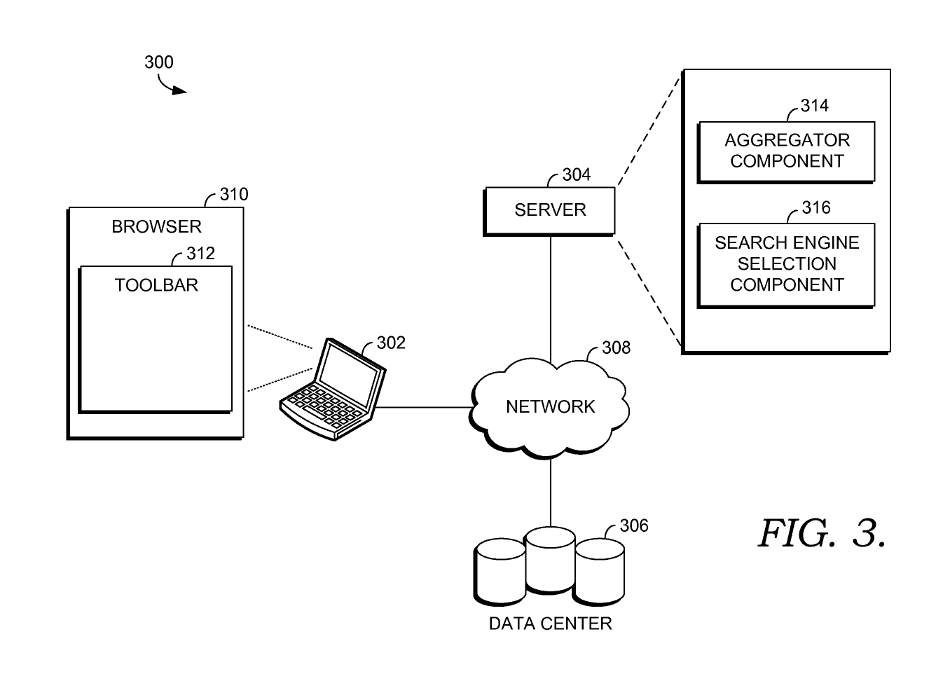

FIG. 4 illustrates a simplified block diagram showing an example of how primary and secondary search results are obtained in accordance with one embodiment.

FIG. 5 illustrates a flow chart for suggesting a different search engine for a user to run a search query in accordance with one embodiment.

FIG. 6 illustrates a flow chart for suggesting a different search engine for a user to run a search query in accordance with one embodiment.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Generally speaking, one aspect is directed to displaying a suggestion to search a different search engine when a user is reviewing search results returned by another search engine. For purposes of discussion, consider the first search engine is Google® and the second search engine is Bing®. In one embodiment, a toolbar extension—such as the Bing® Toolbar—determines a user is frustrated with the results returned by the original search engine (Google®). Because the user is frustrated, the toolbar determines whether another search engine would produce more effective results and thus provide a better search experience. By analyzing historical user session logs, various clickthrough rates (CTRs), and different user characteristics, the toolbar may identify Bing® as yielding better results. The toolbar can then suggest the user conduct the search query on the Bing® search engine, and may even provide a link to effectuate such a search.

Another embodiment uses a toolbar on a web browser to determine a user session has begun. A user session may be begin by a user opening a window for the web browser, opening a new tab in the browser, navigating to a different web page with a uniform resource locator (URL) that substantially differs from the web page currently being rendered, or the like. In the new session, the toolbar determines a user submitted a search query to a search engine and the search engine returned and displayed results in a search results page. Analyzing historical user session data of other users who have submitted the search query to different search engines, a search engine is selected that has historically generated better search results. A suggestion is then presented to the user to run the search query in the more effective search engine. Such a suggestion may be presented in a number of ways, but one embodiment displays a balloon window next to the text field of the toolbar and provides a link to conduct a search for the search query in the more effective search engine. For example, a balloon may say something like, “Still Looking? Bing® has more results,” with any of the words being the link to run the search query in Bing®.

Some embodiments may compare historical user session data, as captured by the toolbar or as monitored by the search engine, for other users who ran the search query on different search engines, or a variation the search query. For example, the Bing® Toolbar may track different characteristics of users' sessions searching for the search query on Yahoo!®, Google®, Bing®, and AOL®. This historical user session data may be used to indicate one of the search engines to suggest to a user. Consider, for example, that a user is running a search on Yahoo!®. A Bing® Toolbar may detect that a session has started and that the user is searching for a particular search query. In one embodiment, the Bing® Toolbar interacts with a search success service on a server to determine which search engine has historically been the most effective in providing results to users for the search query. The most effective search engine can then be suggested to the user, or alternatively, one of the more effective search engines can be suggested. The latter case may come into play when an owner of the toolbar wants to suggest their own search engine that is determined to be one of more effective but not the determined most effective search engine, instead of suggesting a competitor.

Determining which search engines are most/more effective is done, in one embodiment, by calculating values indicative of the search efficacy for particular results. The values may be based on various heuristics aggregated across many different user sessions. Examples of such heuristics include, without limitation, abandonment rates, dwell time, CTRs, quick backs, pagination, requerying, or the like. Some embodiments will use combinations of these heuristics to figure a search engine's efficacy for a particular search query and/or user frustration with search results. Other heuristics may alternatively or additionally be used as well.

Abandonment rates are based on the number of times a user has abandoned a search after receiving search results. A search be considered abandoned when the user types in a URL to an unrelated web page. For example, the user is searching on Bing®, but before selecting a result on a results page, the user navigates to www.espn.com, a sports web site. Or the user simply opens a new tab or browser window and starts navigating to various web sites.

Dwell times refer to the amount of time a user spends viewing a list of search results but takes no action—i.e., the user does not click any links, clicks back, or the like. In one embodiment, the toolbar figures dwell times but capturing the time between when a search results page is rendered and when the user ends a session or takes an action. Some embodiments may also figure user frustration with search results using dwell times. For example, if a user spends ten seconds on a search results page without performing any tasks or starting a new session, a toolbar may interpret that to mean the user is frustrated.

CTRs are standard and should generally be know to those skilled in the art. When a user clicks a link of a search results, a clickthrough may be acknowledged for the search engine producing the link. A CTR, then, is simply a rate based on the registered clickthroughs of users on search results. If, for example, a million users are shown search results for the query “Trip to Hawaii” on Google® and a million are shown search results for the same query on Bing®, each search engine may register a different CTR depending on the number of times users clicked on a result in their respective search results. One embodiment assumes that the search engine with the highest CTR is at least somewhat more effective at providing results fro a specific search query than another search engine with a lower CTR.

Quick backs refer a user being served a search results list and then clicking a back button on a web browser within a certain time period. For example, a user may click back from a results page of Bing® for the search query “Trip to Hawaii” within ten seconds of being presented the results page. Such a scenario may register as a quick back with the toolbar. The time period may differ, of course. Quick backs can be used to indicate user frustration with search results and can also be used to identify the efficacy of a search engine for a search query.

Pagination refers to an instance when a user selects a link in a search results page to view more results. A user may select page 2 of a search results page, for instance. Pagination can be used indicate user frustration with search results and can also be used to identify the efficacy of a search engine for a search query.

Requerying refers to a user submitting another query after search results have been presented and the new query contains at least one of the same substantial words as the original search query. Substantial words in a new search query are considered any words that are not articles (a, an, the, etc. and may include plurals or known variants of words in the original query. One embodiment only registers a requerying if the new search query is submitted during the same session as the original query. An alternative embodiment may register a requery when the later search is performed within a certain time period and includes a substantial word. Requerying can be used indicate user frustration with search results and can also be used to identify the efficacy of a search engine for a search query.

In one embodiment, user frustration with search results is determined based on a combination of quick backs, paginations, or requerying registered during a session. Detection may be done by the toolbar of the browser. The toolbar may also request and receive an indication of one or more alternative search engines to perform a search query. Alternative search engines may be selected based on abandonment rates, dwell times, and a success score of the results historically returned to users by different search engines. The success score may be based on results from a search engine having a certain CTR, relatively low or no abandonment rate, a certain dwell time. Different embodiments may calculate success scores using parameters other than the three mentioned. Because the toolbar extends from a client's web browser, the toolbar may capture far more session data than that which can be captured by the search engine itself. The Bing® Toolbar, for example, can log the actions of users viewing results pages from Google® and Yahoo!®, and the toolbar can recognize when users are accessing those different search engines by checking the URLs of the web pages the user is visiting.

As used herein, “components” refer to a computer-related entity, either hardware, software (e.g., in execution), and/or firmware. Components may operate in a client-server relationship to carry out various techniques described herein. Such computing is commonly referred to as “in-the-cloud” computing. For example, a component may be a process running on a processor, a library, a subroutine, and/or a computer or a combination of software and hardware. By way of illustration, both an application running on a server and the server may be a component. One or more components can reside within a process, and a component can be localized on a computing device (such as a server) or distributed between two or more computing devices communicating across a network.

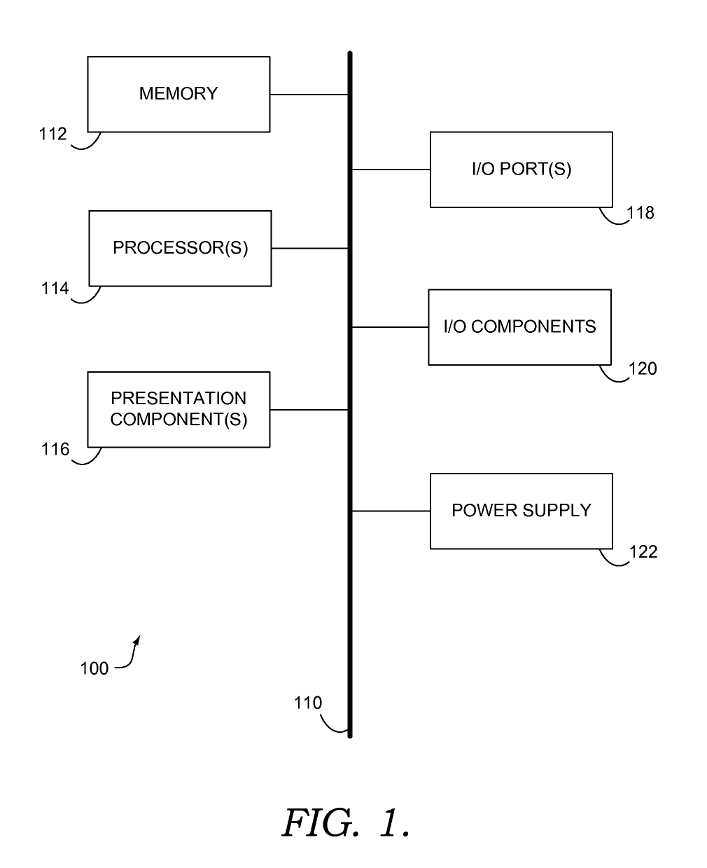

An exemplary operating environment in which various aspects of some embodiments may be implemented is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, smartphone, digital phone, handheld device, BlackBerry®, personal digital assistant (PDA), or other device capable of executing computer instructions.

Embodiments include computer code or machine-useable instructions, including computer-executable instructions such as program modules, being executed by a computer or other machine, such as a PDA or other handheld device. Generally, program modules including routines, programs, objects, components, data structures, and the like, refer to code that perform particular tasks or implement particular abstract data types. Embodiments described herein may be practiced in a variety of system configurations, including hand-held devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, and/or magnetic disk storage or other magnetic storage devices.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

Within memory 102, computing device 100 may have stored web browser and a web browser toolbar or other extension. One skilled in the art will understand and appreciate that various web browsers may be stored, such as, for example, Internet Explorer®, Firefox®, Safari®, or the like. Different search engines may offer various proprietary toolbars and extensions, such as, for example, Bing® Bar, Google® Toolbar, Yahoo !® Toolbar, or the like.

I/O ports 118 allow computing device 100 to be logically coupled to other devices including I/O components 120, some of which may be built in. Illustrative components include a microphone, joystick, game pad, satellite dish, scanner, printer, wireless device, etc.

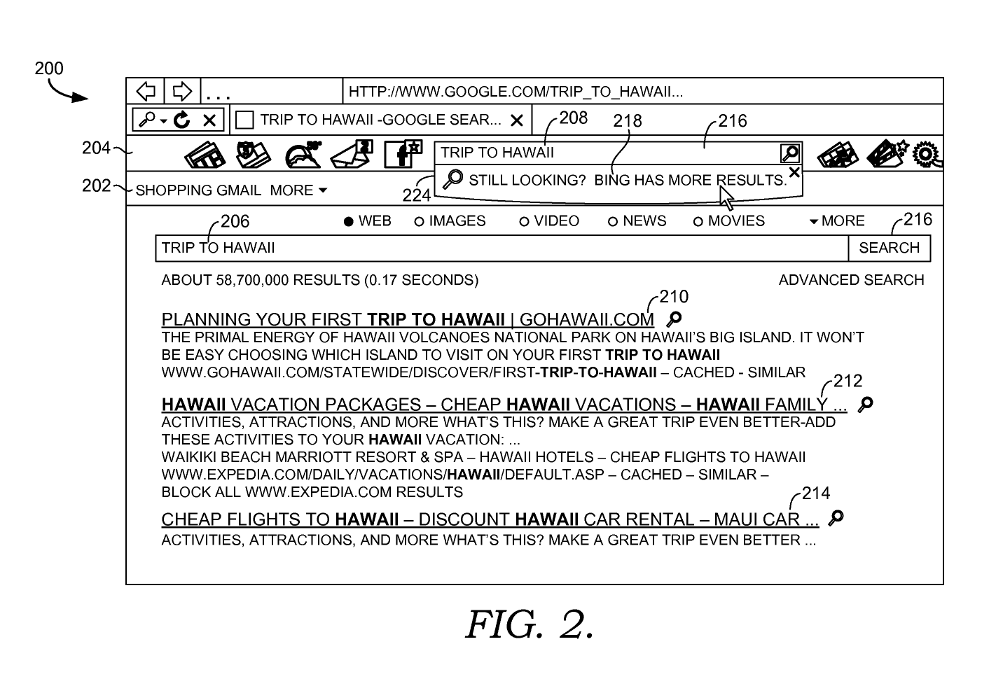

FIG. 2 illustrates a screen shot of a web browser 200 rendering a web page 202 with a toolbar 204 that includes a user-submitted search query 206 in accordance with one embodiment. A user using the web browser navigated to the Google® search engine and performed a search for search query 206 with terms “trip to Hawaii.” Web page 202 shows the resultant search results 210, 212, and 214. Upon hitting Search button 216, toolbar 204 detected that the user was on a web page of the search engine and had submitted search query 206. Toolbar 204 copied search query 206 into text area 216 of toolbar 204—shown as ghosted search query 208. After identifying a more effective search engine to run search query 206, a drop-down suggestion 218 mentioning the different search engine is provided as an extension of toolbar 204 and includes a link that, if selected, navigates to the different search engine and submits search query 206. As shown, the different search engine is Bing® while the original search engine was Google®.

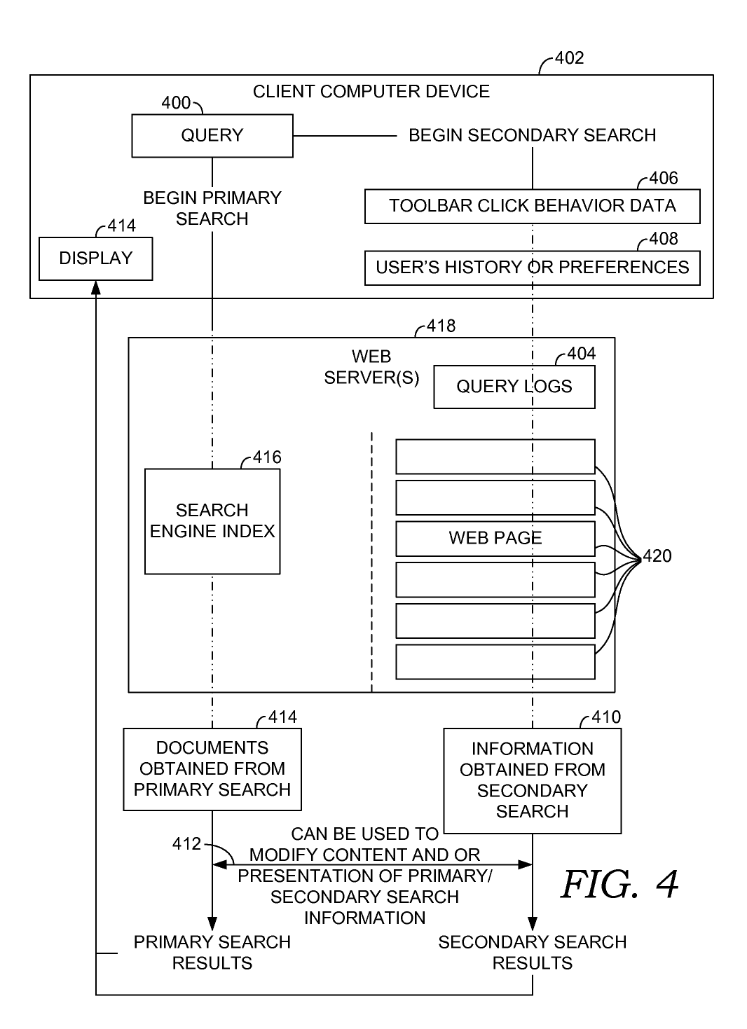

FIG. 4 is a diagram of a networked environment 300 in accordance with one embodiment. Networking environment 300 comprises a client computing device 302, server 304, and database center 306, each able to communicate across network 304. While any of the illustrated devices may communicate with each other, in operation, client computing device 302 communicates with server 304, which functions as a front-end server, and server 304 interacts with data center 306, which functions as a back-end repository for data.

Network 408 may include any computer network or combination thereof. Examples of computer networks configurable to operate as network 408 include, without limitation, a wireless network, landline, cable line, fiber-optic line, local area network (LAN), wide area network (WAN), metropolitan area network (MAN), or the like. Network 308 is not limited, however, to connections coupling separate computer units. Rather, network 308 may also comprise subsystems that transfer data between servers or computing devices. For example, network 308 may also include a point-to-point connection, the Internet, an Ethernet, a backplane bus, an electrical bus, a neural network, or other internal system.

Client computing device 302 may be any type of computing device, such as device 100 described above with reference to FIG. 1. By way of example only and not limitation, client computing device 302 may be a personal computer, desktop computer, laptop computer, handheld device, mobile phone, smartphone, electronic tablet, handheld device, or the like. One skilled in the art will understand and appreciate that numerous devices may function as a client in modern client-server computing models.

Client computing device 302 includes browser 310, a web browser like Internet Explorer®, Firefox®, Safari®, or the like. Browser 310 comprises toolbar 310 with various web-browsing features. Although not shown, browser 310 may also include an expression file that stores mappings or tables of correlations between URLs and search engines, and the expression file can be used to determine when a user has navigated browser 310 to a search engine. In one embodiment, the expression file links or otherwise maps URLs to their underlying search engines. For example, the expression file may indicate that www.bing.com, www.google.com, and www.ebay.com are URLs for search engines Bing®, Google®, and eBay®, respectively. The expression file may be updated regularly from server 304 either in a push, pull, or push-pull manner, and may be stored as an extensible markup language (XML), text file (txt), or other type of file capable of associating URLs and search engines.

Client computing device 302 may communicate with server 304 or database center 306 using a transfer protocol, such as, for example, the Hypertext Transfer Protocol (HTTP), Hypertext Transfer Protocol Secure (HTTPS), file transfer protocol (FTP), Transport Layer Security (TLS), Secure Sockets Layer (SSL), or the like.

Server 304 may be any type of server (or servers) capable of executing toolbar update component 416, refinement component 418, data mining component 420, and feedback aggregator 422. Server 304 stores (either in cache, relationally, or on a hard drive) and manages refined search tables 424. Server 304 may run a cloud platform to interact with datacenter 306. One skilled in the art will be familiar with a host of cloud platforms, such as Windows Azure™, SQL Azure™, Google AppEngine, Amazon Web Services, and the like.

Data center 306 stores user session data transmitted from different instance of toolbar 312 downloaded by many users. User session data may include any of the aforementioned heuristics relating to user frustration and efficacy of search engines, such as as abandonment rates, dwell time, CTRs, quick backs, pagination, requerying, or the like. Additionally, user session data may also include logs of URLs visited by users, times spent at those URLs, and user actions during browsing (link selection, new-session initiation, etc.).

Aggregator component 314 collects user session and log data from numerous instances of toolbar 312 and, in one embodiment, stores the data on data center 306. Toolbars 312 may be configured to periodically (e.g., every twelve hours) transmit the user session, log, and/or click data to aggregator component 314. Storing users' session, log, and/or click data, which includes all the web sites and many of the actions users take, makes data center 306 a robust database of web traffic and interaction across all search engines—not just one that may be associated with toolbar 312. For example, the Bing® Toolbar can collect data on how users interact with Yahoo!®, Google®, and Aol®; whereas, Bing® the search engine can only monitor user actions on Bing®.

During a session, toolbar 312 captures user session data and monitors the session for user frustration. User frustration may be based on any combination of the heuristics mentioned herein, as well as others not specifically mentioned but well-known to those skilled in the art. For example, toolbar 312 may determine a user is frustrated based on registered quick backs, pagination, and requerying. If toolbar 312 determines the user is frustrated, toolbar 312 may, in one embodiment, search engine selection component 316 on server 304 and request an alternative search engine to suggest to the user for conducting a specified search query. To that end, toolbar 312 may pass the search query submitted by the user to search engine selection component 316, which, in turn, queries data center 306 for the most effective search engine at handling the search query. Queries to data center 306 may be made in any well-known way, such as by submitting jobs, via scripts in a scripting language, such as the Structured Computations Optimized for Parallel Execution (SCOPE) or the like.

Data center 306 may return a list of search engines and corresponding success values associated with the search engines handling of the search query. The success values may be based on any of the aforesaid heuristics, but one embodiment in particular bases the success values on the abandonment rates, CTRs, and dwell times of users previous sessions. Any of the search engines in the list may be returned to toolbar 312. The highest rated—by way of the success values—search engine may be returned, or in some circumstances, a default search engine may be returned if the default search engine makes is in the top few or within a certain percentage of the top group of search engines. To illustrate this latter scenario, consider Bing® may be returned to toolbar 312 if it is in the top three search engines when toolbar 312 is an instance of the Bing® Toolbar, and thus the owner of toolbar 312 (Microsoft®) has an interest in generating traffic to the Bing® search engine. Numerous other scenarios for selecting the optimum search engine to return may be used.

Toolbar 312 suggests to the user to conduct a search on the new, different search engine. If the user opts to conduct such a search, browser 310 submits a request to the new, different search engine to search for the search query. The user need not enter the search query twice, in one embodiment, as a ghosting feature may copy the search query directly into a text field of toolbar 312. Alternatively, the suggestion may be made in web page being rendered adjacent to a text field for of the search engine—i.e., not in the text field of toolbar 312—alleviating the need to copy the search query to the toolbar. Numerous other ways to suggest the user run the search in the new, different search engine may also be used.

At least one embodiment also considers secondary search results, in conjunction with primary search results, when suggesting a search query be performed by a different search engine. Secondary search results may be considered when calculating the efficacy of a search engine for returning better results than the search engine chosen by the user. Secondary search results may also be considered when determining user frustration. For example, if a user does not select a primary search result but does select a secondary search result during a certain dwell time, one embodiment determines that the user is not frustrated even though a primary search was not clicked in during the dwell time. Or, in another example, a quick back registered on a secondary search result may signal user frustration, even though the user never performed a quick back on a primary search result. Many other examples are also contemplated by the embodiments herein.

FIG. 4 illustrates a simplified block diagram 400 showing an example of how primary and secondary search results are obtained in accordance with one embodiment. As can be seen in FIG. 4, a primary search for a user-submitted search query 400 on client computer device 402 involves carrying out a keyword search on a search engine hosted on one or more web servers 418 conventionally using a search engine index 416 of numerous web pages 420 to obtain a plurality of documents. In contrast, a secondary search involves mining information from web sites that may include other useful third-party sources, and utilizing query logs 404, toolbar click behavior data 406, a user's history or preferences 408, or the like to generate content relevant to search query 400. Information obtained from the secondary search is denoted by reference numeral 410, and documents from the primary search is denoted by reference numeral 414 As indicated by double-arrow line 412, information obtained from the secondary search 410 can be used to alter primary search results 414, and vice versa. Primary and secondary search results 410 and 414 are provided to the user via display unit 414 of client computer device 402.

Some embodiments enhance a user's search experience by discovering useful sources of information among third-party sources or query logs or content of returned primary search results 414 and automatically generating content relevant to the user's intent. More specifically, these embodiments present information to a search engine user by leveraging third-party sources or query logs or the query string or returned search results or both/all and extracting content relevant to the query or any question related to the query. The extracted content is aggregated into a summary or list for quick understanding and quick access to a specific aspect of the query the user is interested in. Thus, in some embodiment, third-party data is used to directly meet the user's needs by anticipating the question(s) the user is trying to answer and displaying different possible answers, in addition to the primary search results, in the form of external links, summaries, and additional displayed content. It should be noted that summary content may be dynamically created (in real-time), based on the query, returned primary search results, and third-party data, such that the summaries have high likelihood of more directly addressing the user's needs. Details and examples regarding how secondary search results are derived in various embodiments are described below.

Different embodiments can use one or more different techniques to determine and display relevant content. In one embodiment, third-party content is used to determine the most important phrases or sentences within returned primary search results or among third-party sources or both to produce a summary. Third-party content, in one embodiment, is arranged based on popularity of displayed links via toolbar click behavior data. In one embodiment, displayed content is also personalized based on a user's history or preferences. Displayed content, in another embodiment, can be a link to a disambiguation page, which contains an ordered list of third-party information based on a user's history. For example, if the user issued the same query previously and chose the third item (for example, Texas the band instead of Texas the state) on the disambiguation list, then that item will be repositioned to the top of the list in the future. Items can also be repositioned based on popularity, as measured by toolbar data. For example, pages of a particular online encyclopedia (hereinafter referred to as online encyclopedia X) can be positioned in the disambiguation list based on the frequency of user clicks. In one embodiment, content can also be temporally displayed, so that more recently updated third-party content is positioned higher than older content.

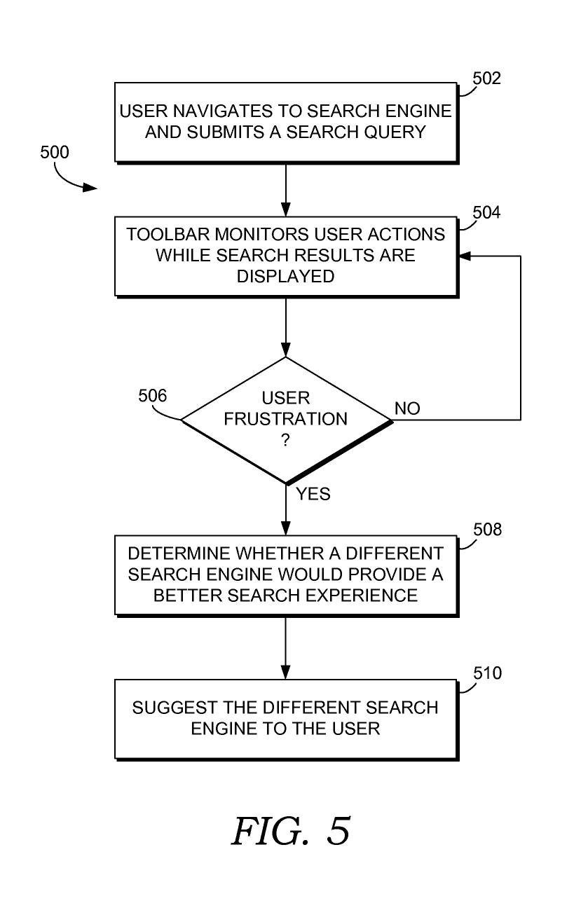

FIG. 5 illustrates a flow chart for suggesting a different search engine for a user to run a search query in accordance with one embodiment. Flow 500 begins when a user navigates to a search engine web page and enters a search query on a client computing device, as shown at 502. Search results—primary and/or secondary—are retrieved by the search engine and presented to the user. As shown at 504, a toolbar on the client's browser monitors the user's actions while search results are displayed. The toolbar monitors whether the user is frustrated with returned search results, as shown at 506. As mentioned above, user frustration may be based on a any combination of different heuristics, such as, for example, abandonment rates, dwell times, CTRs, quick backs, pagination, requerying, of the like. As indicated by the NO path from decision box 506, the toolbar continuously monitors a user's session on the search engine until either user frustration is detected or the session is ended (e.g., the user closes a browser window, navigates to an unrelated web site, opens a new tab, or otherwise ends the search experience).

Once user frustration is detected, the toolbar contacts a server to determine whether a different search engine would provide a better search experience for the search query, as shown at 508. A better search experience may include different search results, as determined by historical session, log, and/or click data from numerous users. The different search engine may be identified and selected based on any combination of the heuristics described herein. One embodiment in particular considers abandonment rates, CTRs, and dwell times of other users on search results pages for various search engines to identify the different search engine. Once selected, and in some embodiments returned to the toolbar from a server, the different search engine is suggested to the user, as shown at 510. In one embodiment, such a suggestion is made by displaying a balloon with a link that, if selected, initiates a search for the search query in the different search engine. For example, if the search query “Trip to Hawaii” was originally run on Google® and Bing® was determined to be a efficacious search engine, a balloon would be displayed with a link to search for “Trip to Hawaii” on Bing® would be displayed.

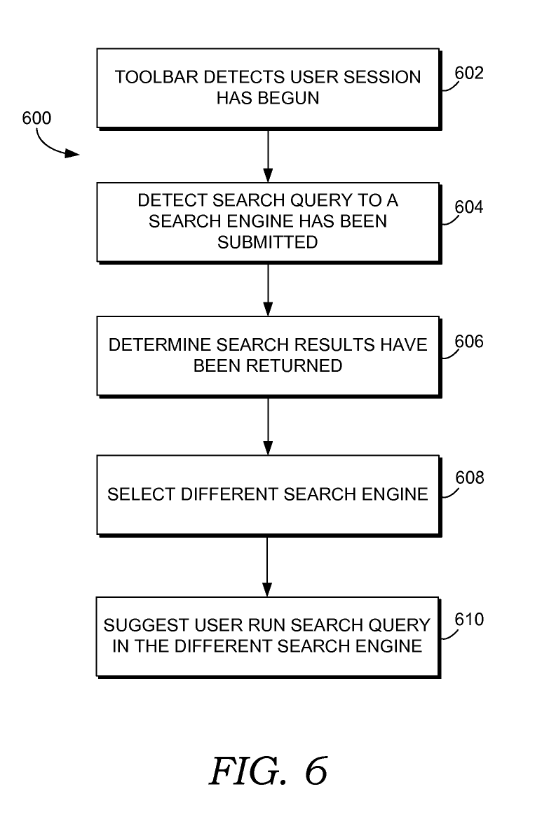

FIG. 6 illustrates a flow chart for suggesting a different search engine for a user to run a search query in accordance with one embodiment. Flow 600 begins when a toolbar detects a user session has begun, as shown at 602. A user session may start whenever a user navigates to a particular web site for a search engine, as shown at 602. Once the user session begins, the toolbar detects a search query being submitted to a search engine and detects that resultant search results have been received and are displayed, as shown at 604 and 606. Based on heuristics detected during the session, the toolbar determines that a user is frustrated with the search results—which may include primary and secondary sources. As a result, a different search engine is selected based on analyzing historical users sessions associated with searches for at least one of the major terms in search query, as shown at 608. Major terms include any keyword that is not an article (a, an, the, etc.) or that is a plural, or obvious variant, of one of the keywords in the search query. And the search engine selected may be chosen because the results the search engine returns for the search query have generated more user interaction, or perhaps less user frustration, than other search engines. In some embodiments, however, the search engine selected may be chosen for being in a top few search engines, for example when the toolbar has a relationship with the search engine (Bing® Toolbar and Bing® search engine). Eventually, the different search engine is suggested to the user as a viable alternative to running the search query, as shown at 610.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. A computer-implemented method for displaying a suggestion to search a different search engine, method comprising:
using a toolbar on a web browser to determine a user session has begun;
determining a user is frustrated with a search query conducted on a search engine based on historical user session data captured by the toolbar, including at least one quick back that indicates the user clicked a back button on a web browser when presented with a results page for the search query conducted by the search engine;
determining the different search engine provides a better search experience based on a search success score captured by the toolbar comprising a clickthrough rate (CTR); and
displaying a suggestion indicating the different search engine, the link including a path that, if selected, submits the search query to the different search engine.

2. The computer-implemented method of claim 1, further comprising:
receiving a user selection of a hyperlink within the suggestion; and
displaying a results page of the different search for the search query.

3. (canceled)

4. The computer-implemented method of claim 1, wherein determining a user is frustrated is based on historical user session data including an indication the user clicked a link on a results page from the search engine to view a second page of results.

5. The computer-implemented method of claim 1, wherein determining a user is frustrated is based on the user submitting a new search query that includes at least one term of the search query.

6. The computer-implemented method of claim 1, wherein determining the different search engine provides a better search experience is based on an abandonment rate determined from previous search queries.

7. The computer-implemented method of claim 1, wherein determining the different search engine provides a better search experience is based on the search success score further comprising:
a determination that a historical user did not abandon a resultant search results page after conducting the search query, and a determination that the historical user stayed on the resultant search results page for at least a length of time.

8. The computer-implemented method of claim 7, wherein determining the different search engine provides a better search experience is based on an abandonment rate determined from previous search queries and the search success score.

9. The computer-implemented method of claim 1, further comprising:
determining, based on historical session logs of users, frustration of users with results from a plurality of search engines conducting the search query; and
based on the frustration of the users, selecting the different search engine from the plurality of search engines.

10. The computer-implemented method of claim 1, further comprising:
determining, based on historical session logs of users, frustration of users with results from a plurality of search engines conducting the search query; and
determining the different search engine historically resulted in a different level of frustration when conducting the search query.

11. One or more computer-storage media storing computer-executable instructions that, when executed by a processor, perform a method for displaying a suggestion to search a different search engine, method comprising:
using a toolbar on a web browser to determine a user session has begun;
determining with the toolbar that a search query was submitted by the user during the session and search results page resulted from the search query being conducted by a search engine;
selecting the different search engine to run the search query based on analysis by the toolbar of historical user sessions associated with searches for at least one term in the search query; and
displaying the suggestion to search the different search engine based on the different search engine being selected.

12. The computer-storage media of claim 11, wherein determining the search query was submitted by the user during the session and the search results page resulted from the search query being conducted by a search engine comprises analyzing one or more uniform resource locators (URLs) during the user session or analyzing content of one or more web pages.

13. The computer-storage media of claim 11, further comprising:
determining frustration of the user during the session based on one or more quick backs that indicates the user clicked a back button on a web browser when presented with the search results page for the search query conducted by the search engine.

14. The one or more computer-storage media of claim 13, further comprising determining frustration of the user during the session based on an indication the user clicked a link on a results page from the search engine to view a second page of results

15. The one or more computer-storage media of claim 13, further comprising determining frustration of the user during the session based on the user submitting a new search query that includes at least one term of the search query.

16. The one or more computer-storage media of claim 11, further comprising:
determining, based on historical session logs of users, frustration of users with results from a plurality of search engines conducting the search query; and
based on the frustration of the users, selecting the different search engine from the plurality of search engines.

17. A computer-implemented method for displaying a suggestion to search a different search engine during a user session of a search engine, method comprising:
using a toolbar on a web browser to detect a beginning of the search session;
receiving a search query;
for a plurality of search engines, determining with the toolbar a value of search results for the search query, the value indicative of the efficacy of the search results relative to the search query;
based on the value, using the toolbar to select the different search engine; and
suggesting a new search for the search query on the different search engine.

18. The computer-implemented method of claim 17, wherein the suggestion to search the different search engine is displayed adjacent to a text field area of a toolbar associated with a web browser.

19. The computer-implemented method of claim 18, wherein the suggestion comprises a hyperlink to the different search engine.

20. The computer-implemented method of claim 19, further comprising:
receiving a selection of the link;
submitting a request to the different search engine to conduct the search query; and
presenting results related to the search query on a web page associated with the different search engine.
